(19) United States
(12) Patent Application Publication
(10) Pub. No.: US 2009/0277127 A1
(43) Pub. Date: Nov. 12, 2009

(54) DECORATIVE AGGREGATE CONCRETE SURFACE PREPARATION PROCESS

(75) Inventors: Ricardo Vasquez, JR., Escondido, CA (US); Jay E. Peterson, Oceanside, CA (US)

Correspondence Address: RICHARD D. CLARKE;LAW OFFICE OF RICHARD D. CLARKE, 3755 AVOCADO BLVD., #1000, LA MESA, CA, 91941-7301, US

(73) Assignee: SINGLE EAGLE, INC., Poway, CA (US)

(21) Appl. No.: 12/436,561

(22) Filed: May 6, 2009

Related U.S. Application Data
(60) Provisional application No. 61/051,406, filed on May 8, 2008.

(51) Int. Cl. E04B 1/16; E04B 1/66; E04G 21/10; C04B 41/53

(52) U.S. Cl. 52/741.11; 52/741.41; 52/742.14; 264/34

(57) ABSTRACT

The present invention is directed to a process of creating a decorative aggregate concrete surface on both a slab on grade installation and a podium deck or topping slab installation. The preparation includes washed decorative aggregate surfaces using a variety of decorative aggregate materials imbedded within a standard concrete mix having a one inch maximum aggregate. A 6-mil polypropylene sheet 435 Visqueen material covered with a two-inch layer of sand is used directly below the concrete to retard the curing time. Roller tamping is used to move the large aggregate below the surface of the concrete material. Power brushes are then used to expose the decorative aggregate prior to the final process of applying a densifing sealer. This process has been designed to reduce installation time, as well as overall labor and material costs.

### FIELD OF THE INVENTION

This patent application is directed to the surface preparation of concrete slabs. More particularly to the incorporation of a washed decorative aggregate surface using a variety of decorative aggregate materials imbedded within standard concrete mix having an aggregate size which will vary from ⅛^{th} inch or less to as much as 1 to 2 inches or more, greatly reducing installation time, labor and material costs.

### BACKGROUND OF THE INVENTION

Exposed aggregate surfaces on concrete have been used for many years with a wide variety of patents filed to fulfill the specific needs of this application. The use of an exposed aggregate surface not only provides a unique decorative surface, it also provides wide variety of other benefits. Exposed aggregate can provide an abrasive, slip resistant surface as well as a smooth very decorative surface. It can also provide a surface with better wear resistance to heavy traffic.

Standard concrete usually comprises coarse aggregate, fine aggregate, cement, additives and water. Varieties of other concrete mixes are available, including a pea gravel (small stone) mix with additional additives available at a higher price. The standard concrete with a coarse aggregate mix is normally used because it provides a stronger product at a lower cost. The coarse aggregate can vary in nature and size up to one inch and often an ornamental aggregate is used as a topping to be exposed on surface. This process is called decorative or surface seeded aggregate. The exposure of the decorative or seeded aggregate is achieved by applying a curing retarder to the concrete surface that will slow the curing process after applying the decorative or seeded aggregate to the surface. The decorative or seeded aggregate is worked to the surface by several different processes. When the concrete has cured the surface to be exposed is brushed or otherwise abraded to remove the cement and fine aggregate between the coarser materials leaving the decorative aggregate surface exposed.

After the concrete has cured, a variety of processes can be used to give different surface textures. Without the addition of decorative or seeded aggregate surfacing materials, the coarse aggregate in the concrete surfaces can be too abrasive due to the nature of the standard concrete stones. Most existing processes call for the use of special concrete mixes, usually pea gravel mix with special additives that is more expensive per yard. Various arrangements and processes have been proposed in the past for accomplishing this process of providing a decorative and durable concrete surface, but they tend to add a great deal more work to install and a good deal of added expense. There is a growing need for reducing the installation time and costs involved in this process.

Numerous innovations for creating an exposed aggregate surface have been provided in the prior art that are described as follows. Even though these innovations may be suitable for the specific individual purposes to which they address, they differ from the present design as hereinafter contrasted. The following is a summary of those prior art patents most relevant to this application at hand, as well as a description outlining the difference between the features of the decorative aggregate concrete surface preparation and the prior art.

U.S. Pat. No. 2,296,453 of George J. Saffert describes a method of molding concrete products. It is the object of this invention to provide a method of forming concrete slabs having the exposed aggregate surface uppermost in the mold. The slabs do not need to be turned over before the cement film on the face surface is removed.

This patent describes a method for molding concrete products such as panels It has not been intended for the procedure of constructing permanent concrete surfaces, such as floors and sidewalks. There is no use of 6-mil poly (Visqueen)) with two inches of sand on top, under the entire surface of the concrete, to be used as a moisture barrier to slow the curing time, specified in this patent. This patent indicates the early uses of the exposed aggregate surfaces in the building industry.

U.S. Pat. No. 4,496,504 of Thomas W. Steenson et al. This invention relates to a method for making a cast concrete panel with the coarse aggregate of the concrete exposed on one face and to a concrete finishing machine. The general process is to pour wet concrete into the form, compact the concrete with a vibrating screed and then level it with roller screeds. In some cases, ribs are formed in the upper surface of the concrete for an ornamental effect.

This patent also describes a method of exposing aggregate in a poured concrete panel. This process uses a unique roller screed rotating in a direction to push excess surface concrete in advance of the screed roller, lifting coarse aggregate towards the upper surface. A unique device using aggregate lifting arms rotating in front of the screed roller lifts the coarse aggregate to the surface. This patent does not incorporate the application of decorative or seeded aggregate. There is no use of 6-mil poly (Visqueen) with two inches of sand on top, under the entire surface of the concrete, to be used as a moisture barrier specified in this patent.

U.S. Pat. No. 4,748,788 of Ronald D. Shaw et al. describes an improved surface seeded exposed aggregate concrete and method of use is disclosed characterized by use of small, rounded aggregate, preferably sand, being broadcast over the upper surface of the concrete. The broadcast aggregate is mixed into the cement paste derived from the concrete matrix by magnesium hand floats and finished by hand sponging. A surface retarder and vapor barrier is then applied to cover the concrete surface for approximately four to twenty four hours. Subsequently, any surface film is washed from the surface of the concrete and the concrete is cured by fogging or soaker hose. Approximately thirty days later, the surface residue is removed from the concrete with a stem/acid wash providing an exposed aggregate concrete having extreme flatness and high wear resistance suitable for high traffic areas and improved aesthetics resembling stone, granite or marble.

This patent describes an improved surface seeded exposed aggregate concrete and method. This is a ⅜ inch pea gravel mix, which requires more cement to meet the similar strength requirements, thus adding additional cost to the process. They suggest that you do not tamp the concrete. There is no use of 6-mil poly (Visqueen) with two inches of sand on top, under the entire surface of the concrete as a moisture barrier to slow the curing time, specified in this patent. This procedure requires the addition of Monterey Aquarium grade course sand be added to the surface prior to seeding aggregates to provide an even paste. Hand sponging is required along with water cure applications. Elmore surface hardener is used and covering the surface with Poly (Visqueen) is required. Hand brushing is required and no densifing sealers are used as a final step.

U.S. Pat. No. 5,441,677 of David L. Phillips, Sr. a method of fabricating a concrete floor having an autogenously hard high gloss finish that does not require further coatings includes pouring a designed concrete mix to establish a slab having an upper surface slightly below the level determined for the finished floor. A finishing floor surface layer is created by applying an amount of a dry shake dressing material containing quartz crystals and a coloring agent, but no coarse aggregate, to the upper surface of the slab. Then floating the surface until the finishing layer reaches predetermined amount, which cures to form a generally monolithic structure with the slab but having a higher compressive strength when fully cured. Necessary expansion joints are provided. The floor is coated with a curing sealer and allowed to cure for approximately 30 days, or until it reaches a predetermined compressive strength. The sealer material is removed and the expansion joints are sealed. The upper surface is then mechanically sanded and polished until a predetermined level of shine or gloss is achieved in the floor surface layer itself.

This patent describes a method of fabricating a concrete floor having an autogenously hard high gloss finish There is no use of 6-mil poly (Visqueen) with two inches of sand on top, under the entire surface of the concrete used as a moisture barrier to slow the curing time specified in this patent. This patent uses a purchased dry shake dressing material such as Master Builders Colorcron®, containing a mixture of Portland cement, silicon and crystalline quartz and optionally containing a color pigment. This patent uses a special custom mix concrete, which adds to the expense of the procedure and a time consuming sanding process to achieve a high gloss finish on the surface of the finished product. No densifing sealer is applied at the end of the curing time.

U.S. Pat. No. 6,016,635 of Lee A. Shaw et al. discloses an improved method of producing surface seeded exposed aggregate concrete upon a sub grade. The method comprises the initial step of pouring a concrete mixture over the sub grade, which is followed by the step of finishing the exposed surface defined by the concrete mixture with a vibrating metal bull float to dispose a quantity of cement/fines paste derived from the concrete mixture at the exposed surface thereof. Thereafter, a quantity of aggregate is broadcast upon the exposed surface of the concrete mixture and subsequently mixed into the quantity of cement/fines paste thereof via the vibrating metal bull float. The exposed surface of the concrete mixture is then finished with a power trowel to facilitate an even distribution of the quantity of aggregate within the quantity of cement/fines paste, which is followed by the application of a surface retarder to the exposed surface of the concrete mixture. The exposed surface of the concrete mixture is then finished with the power trowel to massage the surface retarder into the quantity of cement/fines paste having the quantity of aggregate mixed therein.

This patent discloses an improved method of producing surface seeded exposed aggregate concrete upon a sub grade. There is no use of 6-mil poly (Visqueen) with two inches of sand on top under the entire surface of the concrete, to be used as a moisture barrier to slow the curing time, specified in this patent. This mix is a ⅜ inch pea gravel mix, which requires more cement to meet the similar strengths thus additional cost, and they suggest that you do not tamp. This procedure required mechanical floating and the use of a power trowel. Elmore surface hardener is used. Hand brushing is required and no densifing sealers are used as a final step.

U.S. Pat. No. 6,033,146 of Lee A. Shaw et al. discloses a surface seeded exposed particulate concrete method of use that includes the use of small particulates, the particulates not necessarily chemically inert in the concrete mixture. The particulates are broadcast over the upper surface of the concrete, and mixed into the cement paste derived from the concrete matrix by floats and finished by hand sponging. A surface retarder and vapor barrier are applied, and washing and curing operations follow. The present invention adds a chemical treatment of hydrolyzed alkali silica solution, preferably lithium quartz, penetrating the upper surface of the concrete mixture with minerals and silicates within the concrete mix. The resultant exposed particulate concrete has extreme flatness and high wear resistance suitable for high-traffic flooring applications, aesthetics resembling terrazzo or ceramic tile at a fraction of the price, and the strength and resistance to corrosion expected of concrete surfaces.

This patent describes a surface seeded exposed particulate concrete method of use that includes the use of small particulates, the particulates not necessarily chemically inert in the concrete mixture. There is no use of 6-mil poly (Visqueen) with two inches of sand on top under the entire surface of the concrete, to be used as a moisture barrier to slow the curing time, specified in this patent. This mix is a ⅜ inch pea gravel mix, which requires more cement to meet the similar strengths thus additional cost, and they suggest that you do not tamp. Hand sponging is required along with water cure applications. Elmore surface hardener is used and covering the surface with poly (Visqueen) is required. Hand brushing is required and some densifing sealers are used as a final step.

U.S. Pat. No. 7,322,772 of Lee A. Shaw et al. describes a method and a surface seeded exposed aggregate concrete product are provided that precisely simulate the appearance and qualities of various types of natural quarried stone, such as granite, marble, rhinestone, bluestone, and brownstone, to name a few. Implementations of the present invention are characterized by the use of fine sand and aggregate broadcast over the exposed surface of poured concrete, which surface has been prepared to receive the same. Subsequently, a surface retarder and finishing steps are performed to produce the concrete product which assimilates the characteristics and colors of natural quarried stone, such as speckles, inclusions, flecks, graining, fractures, joints, knots, crystallization patterns, streaks, weathering, etc.

This patent describes a method and a surface seeded exposed aggregate concrete product, which precisely simulate the appearance and qualities of various types of natural quarried stone. There is no use of 6-mil poly (Visqueen) with two inches of sand on top under the entire surface of the concrete, to be used as a moisture barrier to slow the curing time, specified in this patent. This mix is a ⅜ inch pea gravel mix, which requires more cement to meet the similar strengths thus additional cost, and they suggest that you do not tamp. The aggregate is applied pneumatically and mechanical floating and troweling is required. Water curing applications are also required. Elmore surface hardener is used and hand brushing is required. Densifing sealers are used as a final step.

None of these previous efforts, however, provides the benefits and savings derived by the decorative aggregate concrete surface preparation described in this application. The present design achieves its intended purposes, objects and advantages over the prior art processes through a new, useful and unobvious combination of method steps and component elements, at a reasonable cost to provide, and by employing readily available materials.

In this respect, before explaining at least one embodiment of the decorative aggregate concrete surface preparation in detail it is to be understood that the design is not limited in its application to the details of construction and to the arrangement, of the components set forth in the following description or illustrated in the drawings. The decorative aggregate concrete surface preparation described herein is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other methods and systems for carrying out the several purposes of the present design. It is important, therefore, that the claims be regarded as including such equivalent construction insofar as they do not depart from the spirit and scope of the present application.

### SUMMARY OF THE INVENTION

The principal advantage of the decorative aggregate concrete surface preparation is by using the standard concrete mix having a one-inch maximum aggregate base material, it reduces the potential for shrinkage and increases the adhesion potential for the smaller aggregates.

Another advantage to the decorative aggregate concrete surface preparation is by using a 6-mil poly (Visqueen) moisture barrier, the moisture in the concrete mix is not allowed to quickly dissipate into the sub base and surrounding soil extending the curing time. This is extremely valuable in temperate climates.

Another advantage is, by using a roller tamp device, the large aggregate of the standard concrete mix is moved down from the surface.

Another advantage is by using a power brush to remove the sediment from the decorative aggregate surface a great deal of time and labor is saved.

Another advantage of the decorative aggregate concrete surface is that when the densifing sealer is applied in the final process at the end of the curing time, a better surface hardness, enhanced aggregate adhesion, and exposed aggregate sealing is achieved.

These together with other advantages of the decorative aggregate concrete surface preparation, along with the various features of novelty, which characterize the process, are pointed out with particularity in the claims annexed to and forming a part of this disclosure. For a better understanding of the decorative aggregate concrete surface preparation, its operating advantages and the specific objects attained by its uses, reference should be made to the accompanying drawings and descriptive matter in which there are illustrated the preferred embodiment of the decorative aggregate concrete surface preparation.

For the installation of the decorative aggregate concrete surface preparation, the propose grade shall be on a soils compacted to a minimum of 90% and per city specifications. Sub grade to be within a tenth of a foot, ready to receive required base material. Sub base should be tested by a licensed certified soils engineer to insure proper moister content and compaction has been achieved it is suggested that a minimum of two inches of approved sub base i.e., class II base, ¾″ gravel or se 30 sand be utilized, but is not required. A moisture barrier of 6-mil poly (Visqueen) is laid over the sub base and covered with a layer of two inches clean washed sand to be fine graded in place to allow for the proper thickness of concrete. This provides a moisture content that is essential for proper curing and hydration of the proposed decorative aggregate concrete surface.

A minimum requirement of 3000 PSI standard concrete design mix consisting of 1 inch minus concrete aggregate, including a mid-range water reducer that meets ASTM C-494 Type A+F admixture (such as MasterBuilders “Polyheed” or Euclids EUCON MR) are required for this application process. Flyash can replace cement content up to 15% but in no case will cement content exceed 6-½-sack concrete mix. The concrete mix Should not exceed a six-inch slump test. On occasion, virgin homopolymer-polypropylene multi-filament fibers (such as Fibermesh 150) can be used for increased durability.

Decorative aggregate material should be selected, and proper portions determined to accommodate the desired finish. The decorative aggregate material should be cleaned and washed prior to installation. Note: that the aggregate size will vary from ⅛^{h} inch or less to as much as 1 to 2 inches or more. The mean average of ½ to ⅝ inch will be the normal application for aggregates such as shells, glass or rock. The decorative aggregate per square foot portions will vary based on the percentage of coverage and decorative aggregate type selected. Various types of aggregate such as glass, shells, rock, metals, plastics, rubber, organic materials, or exposed particulates, not necessarily chemically inert, in the concrete mixture will be utilized. One pound to one and one half pounds per square foot is considered the typical amount to achieve 100% surface coverage required. At least 25% additional materials should be figured and available on site to assure the proper selected percentage of coverage. It should be noted that the weight of any given seeded material may vary, and in all likelihood will vary.

A minimum of #3 (⅜ inch) rebar should be placed at 18 inches on center in both directions (each way). The rebar should be placed on adobe riser blocks within the middle thickness of the proposed concrete slab. When joining two separate concrete pours together, slip dowels are recommended. Appropriate expansion, construction and control joints shall be installed at strategically placed locations to minimize the potential for random cracking.

Prior to the spreading of the decorative aggregate all personnel will be required to know their responsibility for the concrete pour. A sufficient number of experienced place and finish personnel will be designated for each concrete pour. The same crew will be utilized for all required individual projects for consistency of the finished product. It is important that during the spreading process of the decorative aggregate the concrete is to be left lower than adjacent edges of the forms. A rise in concrete elevations will take place during the spreading of decorative aggregates thus elevating the concrete surface to the desired elevation required or to adjacent surfaces.

A roller tamp will be utilized to lightly bury the larger aggregates no more than ⅜-½ of an inch below the decorative aggregate surface when utilizing a 1 inch minus concrete mix design. The mix designs may vary depending on the desired finish and the type decorative aggregate selected.

The surface of the concrete should be floated with a wood, resin or magnesium bull float and allow sufficient time for the water to rise to the surface. The process of spreading the decorative aggregate is required to start prior to bleed water evaporation from the concrete. All edges are to be hand floated and the appropriate edgers must be used at this time to insure the rock in the concrete mix is pushed down to the proper elevation prior to the spreading of aggregates.

Selected decorative aggregates to be spread should be prepared and placed along the pour areas to be readily available when the need arises. Spreading should be done in a uniform manner with the designated crew to insure the proper and desired consistency is achieved throughout the project. One lead person will be responsible for the proper application of decorative aggregate materials and desired surface finishes.

Once the spreading of the decorative aggregate has occurred, the concrete surface should be floated with resin or magnesium floats in a timely manner to imbed the materials to a depth approximately ⅛ to ¼ of an inch below the surface. Hand floats must also be utilized to manipulate the embedment of the decorative aggregate material into the surface with a circular motion using a flat angle trowel position to insure proper embedment of the decorative aggregate. Special care is required to eliminate tie potential for over-embedment of the decorative materials. In some cases, lightly tamping may be required. The decorative aggregate surface should be allowed to release any additional bleed waters before finish trowels are applied.

All proper conventional finishing techniques should be utilized and followed to give the concrete surface a once-over smooth trowel finish and leave ready to receive the application of the retarder. After the embedded decorative aggregate process has been completed, the surface should only be toweled one time prior to the application of the surface retarder. This process must be completed exactly the same way on multiple concrete pour projects to insure the same finish will be obtained.

A surface retarder consisting of propylene glycol, citric acid and 5-cloro-2methyl-2H-isothiazol-3-one (such as Grace Top Cast 150® or a similar compound) shall be applied per manufactures recommendations. Various grades of surface retarders may be applied depending on the decorative aggregate type and desired finish selected. Proper containment of surface wash should be taken to abide to local, state and federal environmental laws. When washing, it is recommended to use a floor maintainer (buffer) with a stiff brush and ample amounts of water. Scrubbing should be done until the desired finish is acquired. An acid solution may be necessary prior to any sealing of the surface. One last buff wash should be applied just prior to the sealing process.

Proper curing methods should be utilized and a 28-day curing period is required prior to the application of a densifing sealer that is required for this type of finish. The surface may be kept moist to help the hydration process, but it is not necessarily required because of the 6-mil poly (Visqueen) used as a moisture barrier below the concrete.

After a 28-day curing period and final buff wash it is time to apply a densifing sealer. It is highly recommended that a densifying sealer be applied. The densifying sealer should consist of lithium silicate such as Prosoco Consolideck LS or lithium quartz such as Sinak HLQ-125. Once any of the referenced products are applied, per manufacturer's recommendations, this will properly densify and seal tile exposed finish completing the decorative aggregate concrete surface preparation process. If desired, an enhancing sealer such as GlazeNSeal, Wet Look 2000, Westcoat SC70 or Schofield Cementone, may be applied to increase the color value, and bring out the vibrant color of the seeded decorative aggregate surface.

The foregoing has outlined rather broadly the more pertinent and important features of the present decorative aggregate concrete surface preparation in order that the detailed description of the application that follows may be better understood so that the present contribution to the art may be more fully appreciated. Additional features of the process will be described hereinafter which form the subject of the claims of this disclosure. It should be appreciated by those skilled in the art that the conception and the disclosed specific embodiment might be readily utilized as a basis for modifying or developing other processes and methods for carrying out the same purposes of the present invention. It should also be realized by those skilled in the art that such equivalent processes and methods do not depart from the spirit and scope of this application as set forth in the appended claims.

### BRIEF DESCRIPTION OF THE DRAWINGS

The accompanying drawings that are incorporated in and form a part of this specification, illustrate embodiments of the decorative aggregate concrete surface preparation.

FIG. 1 depicts a perspective view of the decorative aggregate concrete surface preparation process.

FIG. 2 depicts a block diagram of the decorative aggregate concrete surface preparation process.

For a fuller understanding of the nature and advantages of the decorative aggregate concrete surface preparation, reference should be had to the following detailed description taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

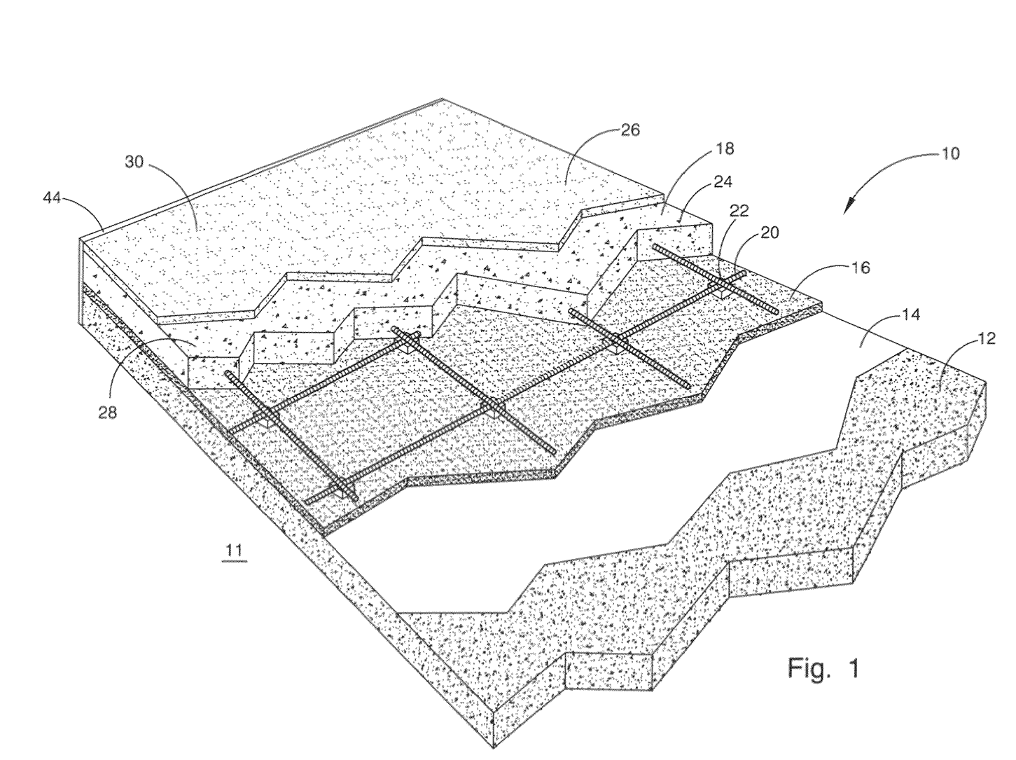

Referring now to the drawings, wherein similar parts of the decorative aggregate concrete surface preparation 10 are identified by like reference numerals, there is seen in FIG. 1 a perspective view of the decorative aggregate concrete surface preparation 10 illustrating the varying layers of the process, as it applies to a slab on grade concrete installation. Above the existing soil 11 will be a suggested layer of road base material 12 at the required thickness compacted to a minimum of 90% compaction. A moisture barrier 14 of 6-mil poly (Visqueen) is layered over the road base material 12 and covered with a layer of two inches clean washed sand 16 to be fine graded in place to allow for the proper thickness of concrete 18. The rebar mat 20 is placed on adobe risers 22 elevating the rebar off the surface and not allowing any of the rebar mat 20 to extend below the lower surface of the concrete. This is important because if any of the metal surface of the rebar mat 20 is exposed the rusting process will extend through out the rebar mat 20 quickly. A minimum requirement of 3000 PSI standard concrete 18 design mix consisting of 1 inch minus concrete aggregate 24, including water reducing chemicals that are required for this application process is illustrated over the rebar mat 20 with the decorative aggregate surface 26 on the top.

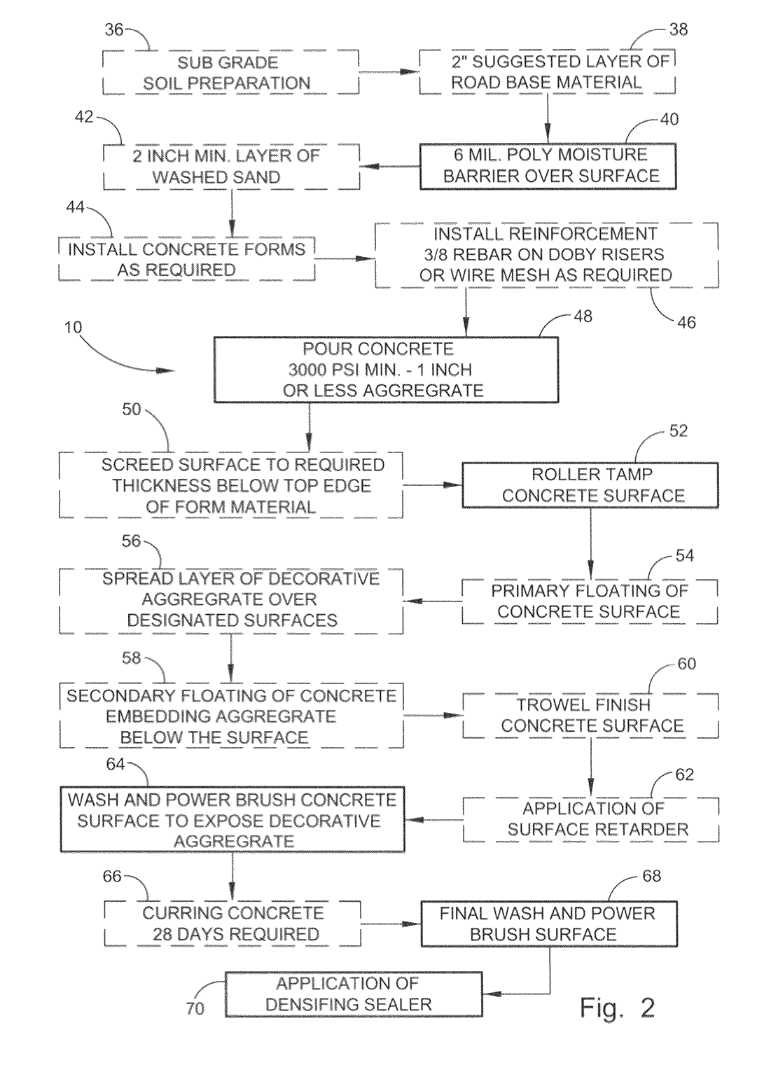

FIG. 2 depicts a block diagram of the decorative aggregate concrete surface preparation 10 illustrating the conventional features of the process in dotted lines and the unique features of the process in bold solid lines. For a podium deck or topping slab concrete installation the sub grade soil prep, 6 mil poly and sand are not required.

The first step of the installation process of the decorative aggregate concrete surface preparation 10 will be the sub grade soil preparation 36, when required, where the proposed grade shall be on a soil compacted to a minimum of 90% and per city specifications. Sub grade to be within a tenth of a foot ready to receive required road base material 12. Next step 38 will be the installation of a 2-inch suggested layer of road base material 12 tested by a licensed certified soils engineer to insure proper moister content and that the proper compaction has been achieved. The following unique step 40 will be the application of the moisture barrier 14 of a 6-mil poly (Visqueen) material over the entire surface. Step 42 will be covering the moisture barrier 14 with a two-inch layer of clean washed sand 16 to be fine graded in place allowing for the proper thickness of concrete 18. For podium decks with waterproofing, this will satisfy the hydration process, and the previous steps will be deleted. The following step 44 will be the installation of the concrete forms 45 around the perimeter of the desired area of the installation. Step 46 will be the installation of the reinforcement ⅜ rebar mat 20 on adobe risers 22 or wire mesh as required. Step 48 will be the pouring of the 3000-PSI min., 1 inch or less aggregate 24 concrete material 18.

After pouring the concrete material 18 in place, step 50 will be to screed the concrete to the required thickness below top edge of concrete forms 45. Step 52 of roller tamping the concrete surface 28 will work the concrete aggregate 24 to the desired depth below the concrete surface 28. The following step 54 of the primary floating of the concrete surface 28 is done just prior to step 56 of spreading a layer of decorative aggregate 30 over designated concrete surface 28. After spreading a layer of decorative aggregate 30 over designated decorative aggregate surface 26 will be step 58 of the secondary floating of concrete embedding decorative aggregate 30 below the decorative aggregate surface 26. It should be noted that steps 56 and/or 58 may need to be repeated to achieve the desired finish based on the selected aggregate material utilized. The aggregate size will vary from ⅛^{th} inch or less to as much as 1 to 2 inches or more.

The decorative aggregate surface 26 should be allowed to release any additional bleed waters before finish trowels are applied. All proper conventional finishing techniques should be utilized and followed to give the decorative aggregate surface 26 a once over smooth trowel finish and leave ready to receive tie application of the retarder. The step 60 of applying a trowel finish to the decorative aggregate surface 26 will be followed by step 62 of the application of a surface retarder, in an even uniform pattern, to the decorative aggregate surface 26.

After a period of four to twenty four hours the decorative aggregate surface 26 will have reached a relative hardness where step 64 of washing and power brushing the decorative aggregate surface 26 to expose decorative aggregate 30 may be accomplished. When washing, it is recommended to use a floor maintainer (buffer) with a stiff brush and ample amounts of water. Scrubbing should be done until the desired finish is acquired. An acid solution may be necessary prior to any sealing of the surface. One last buffing wash should be applied just prior to the sealing process. Step 66 indicates a curing period of a minimum of 28 days before the step 68, the final wash and power brushing of the decorative aggregate surface 26 and step 70, of the application of tile densifing sealer can be accomplished to complete the procedure of the decorative aggregate concrete surface preparation 10. Finally, the application of an optional enhancing sealer can be performed to achieve a maximum vibrant color appearance of the decorative aggregate.

The decorative aggregate concrete surface preparation 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a decorative aggregate concrete surface preparation 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

We claim:

1. A decorative aggregate concrete surface preparation process for concrete poured to a podium deck or topping slab, comprising the steps of:
(a) installing concrete forms as required and installing reinforcement bars;
(b) pouring concrete to a minimum specification of about 3000 psi;
(c) screeding the concrete surface to the required thickness below the top edge of any form material
(d) roller tamping the concrete surface;
(d) spreading a layer of decorative aggregate over designated surface areas followed by a primary floating and secondary floating of concrete surface before trowel finishing;
(e) applying a surface retardant;
(f) washing and power brushing concrete surface to expose decorative aggregate;
(g) curing the poured concrete for about 28 days before a final washing and power brushing of concrete surface; and
(h) applying a densifying sealer to the exposed decorative concrete surface.

2. The decorative aggregate concrete surface preparation process for concrete poured to a podium deck or topping slab according to claim 1, wherein said step of spreading a layer of decorative aggregate followed by a primary floating and secondary floating of concrete surface before trowel finishing is repeated as necessary.

3. The decorative aggregate concrete surface preparation process for concrete poured to a podium deck or topping slab according to claim 1, wherein said step of pouring concrete to a minimum specification of about 3000 psi, further includes the step of pouring concrete to a minimum specification of about 3000 psi to about 5000 psi as required.

4. The decorative aggregate concrete surface preparation process for concrete poured to a podium deck or topping slab according to claim 1, wherein said step of spreading a layer of decorative aggregate over designated surface areas includes spreading natural and synthetic decorative aggregate materials including glass, shells, rock, metals, plastics, rubber, organic materials, inorganic materials, chemically inert particulates, and chemically active particulates.

5. The decorative aggregate concrete surface preparation process for concrete poured to a podium deck or topping slab according to claim 1, wherein said step of primary floating and secondary floating of concrete surface before trowel finishing includes the step of floating by hand.

6. The decorative aggregate concrete surface preparation process for concrete poured to a podium deck or topping slab according to claim 5, wherein said step of primary floating and secondary floating of concrete surface before trowel finishing includes the step of floating by hand using a wood, resin or magnesium float.

7. The decorative aggregate concrete surface preparation process for concrete poured to a podium deck or topping slab according to claim 1, wherein said step of applying a surface retardant includes the step of applying a surface retardant employing a surface retarder consisting of propylene glycol and citric acid.

8. The decorative aggregate concrete surface preparation process for concrete poured to a podium deck or topping slab according to claim 1, wherein said step of applying a densifying sealer to the exposed decorative concrete surface includes the step of applying a densifying sealer to the exposed decorative concrete surface wherein said densifying sealer includes lithium silicate or lithium quartz.

9. The decorative aggregate concrete surface preparation process for concrete poured to a podium deck or topping slab according to claim 1, wherein said step of washing and power brushing includes the step of washing and power brushing after a period of four to twenty four hours following the application of a surface retarder.

10. The decorative aggregate concrete surface preparation process for concrete poured to a podium deck or topping slab according to claim 1, wherein said step of applying a densifying sealer is followed by application of an enhancing sealer to bring out the vibrant color of the decorative aggregate.

11. A decorative aggregate concrete surface preparation process for concrete poured to a slab on grade installation, comprising the steps of:
(a) preparing the sub grade soil and applying a suggested 2 inch layer of road base material;
(b) laying down a 6 mil. polypropylene Visqueen moisture barrier over the prepared surface and adding a 2 inch layer of washed sand;
(c) installing concrete forms as required and installing reinforcement bars;
(d) pouring concrete to a minimum specification of about 3000 psi;
(e) screeding the concrete surface to the required thickness below the top edge of any form material and roller tamping the concrete surface;
(f) spreading a layer of decorative aggregate over designated surface areas followed by a primary floating and secondary floating of concrete surface before trowel finishing;
(g) applying a surface retardant;
(h) washing and power brushing concrete surface to expose decorative aggregate, then curing concrete for about 28 days before a final washing and power brushing of concrete surface; and
(i) applying a densifying sealer to the exposed decorative concrete surface.

12. The decorative aggregate concrete surface preparation process for concrete poured to a slab on grade installation, according to claim 11, wherein said step of spreading a layer of decorative aggregate followed by a primary floating and secondary floating of concrete surface before trowel finishing is repeated as necessary.

13. The decorative aggregate concrete surface preparation process for concrete poured to a slab on grade installation, according to claim 11, wherein said step of pouring concrete to a minimum specification of about 3000 psi, further includes the step of pouring concrete to a minimum specification of about 3000 psi to about 5000 psi as required.

14. The decorative aggregate concrete surface preparation process for concrete poured to a slab on grade installation, according to claim 11, wherein said step of spreading a layer of decorative aggregate over designated surface areas includes spreading natural and synthetic decorative aggregate materials including glass, shells, rock, metals, plastics, rubber, organic materials, inorganic materials, chemically inert particulates, and chemically active particulates.

15. The decorative aggregate concrete surface preparation process for concrete poured to a slab on grade installation, according to claim 11, wherein said step of primary floating and secondary floating of concrete surface before trowel finishing includes the step of floating by hand.

16. The decorative aggregate concrete surface preparation process for concrete poured to a slab on grade installation, according to claim 15, wherein said step of primary floating and secondary floating of concrete surface before trowel finishing includes the step of floating by hand using a wood, resin or magnesium float.

17. The decorative aggregate concrete surface preparation process for concrete poured to a slab on grade installation, according to claim 11, wherein said step of applying a surface retardant includes the step of applying a surface retardant employing a surface retarder consisting of propylene glycol and citric acid.

18. The decorative aggregate concrete surface preparation process for concrete poured to a slab on grade installation, according to claim 11, wherein said step of applying a densifying sealer to the exposed decorative concrete surface includes the step of applying a densifying sealer to the exposed decorative concrete surface wherein said densifying sealer includes lithium silicate or lithium quartz.

19. The decorative aggregate concrete surface preparation process for concrete poured to a slab on grade installation, according to claim 11, wherein said step of washing and power brushing includes the step of washing and power brushing after a period of four to twenty four hours following the application of a surface retarder.

20. The decorative aggregate concrete surface preparation process for concrete poured to a slab on grade installation, according to claim 11, wherein said step of applying a densifying sealer is followed by application of an enhancing sealer to bring out the vibrant color of the decorative aggregate.
